(19) United States
(12) Patent Application Publication
(10) Pub. No.: US 2007/0233850 A1
(43) Pub. Date: Oct. 4, 2007

(54) User status control for a messaging interface

(75) Inventor: Christopher T. Szeto, Sunnyvale, CA (US)

Correspondence Address: BEYER WEAVER LLP, P.O. BOX 70250, OAKLAND, CA, 94612-0250, US

(73) Assignee: YAHOO! INC.

(21) Appl. No.: 11/394,034

(22) Filed: Mar. 29, 2006

(51) Int. Cl. G06F 15/173

(52) U.S. Cl. 709/224

(57) ABSTRACT

Methods and apparatus are described for controlling an online status of a user in a network. A messaging interface is provided with which the user may initiate communication with other users in the network. The messaging interface includes first status information representing the online status of the user. The messaging interface further includes a status control element which is visible in the messaging interface without requiring action by the user. Second status information representing the online status of the user is provided to selected ones of the other users. In response to selection of the status control element, the first and second status information are updated to represent a corresponding change of the online status of the user. The selection of the status control element requires only a single selection action by the user.

### BACKGROUND OF THE INVENTION

The present invention relates to messaging systems and, in particular, to techniques for enabling users to update and manage their status in such systems.

Some messaging systems on the Internet or mobile networks often provide some mechanism by which a user can indicate his current status to others on the network. An example of such a mechanism (illustrated in FIG. 1) is provided in messaging interface 100 of the popular Instant Messenger application created by Yahoo! Inc. of Sunnyvale, Calif. As shown at 102, an icon (i.e., a “smiley face” in this example) and an associated status designation (i.e., “Available”) are associated with the user's screen name. This indicates the user's current online status to the user himself. And as illustrated in 104, this status information may also be represented in the contact lists of other users in the system to whom the user has elected to be visible, e.g., in whose address books the user is included.

By selecting his status information, or by navigating from the top level “Messenger” menu, the user can access a status menu (e.g., menu 106) which provides a number of options for controlling the user's online “presence.” That is, by selecting one of the available options (or even creating a new one by selecting “New Status Message”) the user can change the status information in his own messaging interface and the contact lists of the other users. However, from the perspective of “usability,” this approach could still be improved.

For example, it is not immediately apparent from interface 100 how the user can go about changing his online status. This is particularly problematic for new or infrequent users. In addition, even after a user learns how to change his status, the process for doing so requires at least two “clicks” of the mouse, e.g., accessing the status menu followed by selection of the desired status menu item. This may not seem like much of an issue, but there is ample evidence that users (and particularly experienced users) grow increasingly impatient from being required to perform additional or repetitive steps to access interface functionality, particularly for frequently used interface functions.

It is therefore desirable to provide techniques by which a user can more easily control or manage his online presence in messaging and other applications.

### SUMMARY OF THE INVENTION

According to the present invention, various methods and apparatus are provided for controlling an online status of a user in a network. A messaging interface is provided with which the user may initiate communication with other users in the network. The messaging interface includes first status information representing the online status of the user. The messaging interface further includes a status control element which is visible in the messaging interface without requiring action by the user. Second status information representing the online status of the user is provided to selected ones of the other users. In response to selection of the status control element, the first and second status information are updated to represent a corresponding change of the online status of the user. The selection of the status control element requires only a single selection action by the user.

According to a specific embodiment, a device is provided with which a user may communicate with other users in a network. The device includes a display, a processor, memory having computer-program instructions stored therein, an interface to the network, and at least one switch operable to control an online status of the user in the network. The processor is operable in conjunction with the computer program instructions to provide a messaging interface on the display with which the user may initiate communication with other users in the network. The messaging interface includes first status information representing the online status of the user. The first status information corresponds to second status information representing the online status of the user to selected ones of the other users on corresponding devices. In response to operation of the at least one switch, the processor is further operable to update the first status information to represent a corresponding change of the online status of the user, and to communicate the change of the online status to the network via the interface such that the change is reflected in the second status information.

A further understanding of the nature and advantages of the present invention may be realized by reference to the remaining portions of the specification and the drawings.

### BRIEF DESCRIPTION OF THE DRAWINGS

FIG. 1 illustrates an exemplary messaging interface according to the prior art.

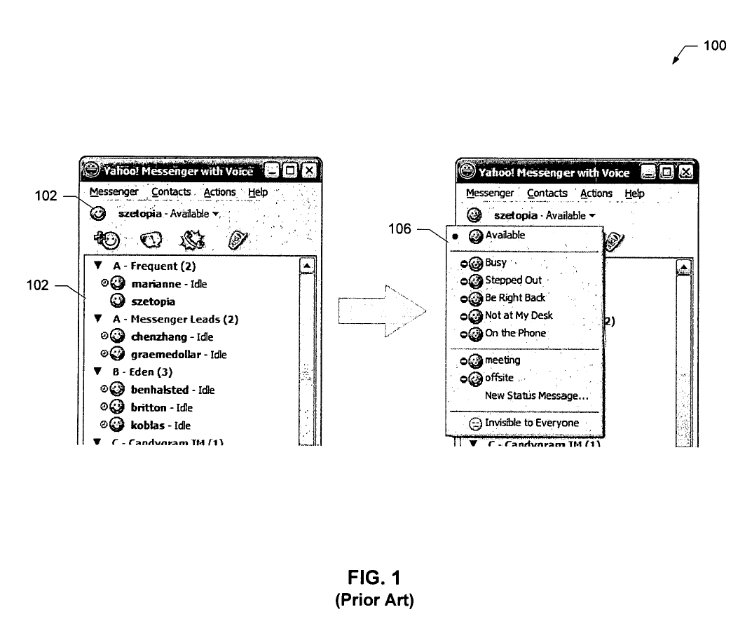

FIG. 2 illustrates an exemplary messaging interface designed in accordance with a specific embodiment of the present invention.

FIG. 3 is an exemplary network diagram illustrating some of the platforms which may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

The present invention provides one or more top-level controls in a messaging interface which enables the user to change his online status with one selection action with an I/O device, e.g., one click of a mouse. Because the control is surfaced to the top level, it makes the corresponding functionality much easier to discover. Instead of navigating menus or having to intuit hidden shortcuts, these controls provide the user with a mechanism for managing his online status which is readily apparent and easy to use. Surfacing the control to the top level of the interface also minimizes the user actions required to manage his online presence.

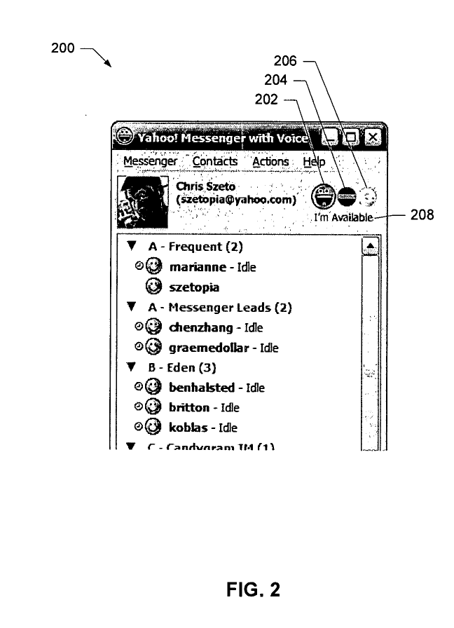

According to a specific embodiment illustrated in FIG. 2, status control elements (e.g., buttons 202, 204, and 206) are provided in an exemplary messaging interface 200. In the example shown, three buttons are provided representing, respectively, that the user is available (e.g., button 202), busy or unavailable (button 204), and offline (button 206). Simply by clicking once on the button corresponding to the desired online status, the user can change his status throughout the messaging system which would then be reflected both in his own messaging interface, and the messaging interfaces of other users in the system.

In the example shown, the user's status is represented by text 208 associated with the status control buttons, as well as by the appearance of the currently active button itself. That is, because the user's status is currently “available,” button 202 is in full color and larger than the other two buttons which are both presented in subdued or washed out tones. When, for example, busy button 204 is selected, the corresponding status will be represented by text 208, and button 204 will increase in size and become a brighter red, while button 202 will decrease in size and become a paler shade of yellow.

It will be understood that the representations of the status information and the status control elements in FIG. 2 are merely exemplary and may be implemented in a variety of ways without departing from the scope of the invention. For example, a button is just one possible control element which may be used to implement the top level control contemplated by the invention. Other possibilities will be apparent to those of skill in the art including, for example, a slider control with different positions for different statuses, a radio control, etc. In addition, buttons having a more conventional appearance and labeled with the corresponding online status could be provided separate from the status information, i.e., above, below, or to the side. Selection of these buttons might affect status information in a spatially separated portion of the interface. Such control elements may or may not have an appearance which indicates that the corresponding status is currently active.

According to some embodiments of the invention, the status control element may be implemented as a physical switch, button, or even a soft key on a device. For example, a telecommunications device such as a cell phone might include such a feature to allow the user to allow the user to enjoy the advantages of the top level control of his online status enabled by the present invention.

A particular status control element might also be configured to activate more than one state of a user's online presence. For example, a button could toggle between or among two or more statuses, e.g., click it once for “available,” click it again for “busy,” click it yet again to become “available” again. Alternatively, successively selecting a single status control element could result in cycling through a sequence of online statuses.

The number, size, and arrangement of status controls in the messaging interface may also vary considerably without departing from the scope of the invention. For example, the three status control buttons of FIG. 2 were selected for exemplary purposes because they represent three of the most commonly used online statuses. However, embodiments are contemplated with as few as one control element, and as many control elements as there are states of the user's online presence. Similarly, while the three buttons are shown in a horizontal row, it will be understood that they could be arranged in a wide variety of configurations.

According to some embodiments, the user may customize the status control buttons in his messaging interface in much the same way that he might customize a tool bar or other portions of the interface. For example, the user may include individual buttons or controls for a number of different status indicators. The user may even name his own status indicators to more closely align with his personality and or habits. According to a specific embodiment, the text status information associated with the status control elements, e.g., text 208 of FIG. 2, may be altered simply by selecting the text and entering replacement text.

And as will be appreciated, the various functionalities described herein may be implemented in a wide variety of ways without departing from the scope of the invention. For example, according to a specific embodiment a messaging interface may be provide in a Web page with the status controls embedded in the page html (e.g., in html or Javascript). However, depending on the computing context and the particular application, a wide variety of other commercially available or proprietary software tools may be employed. For example, the messaging interface may be implemented as a stand-alone widget, as a desktop application or plug-in, or integrated with a desktop application. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing models in which various of the functionalities described herein may be effected or employed at different locations.

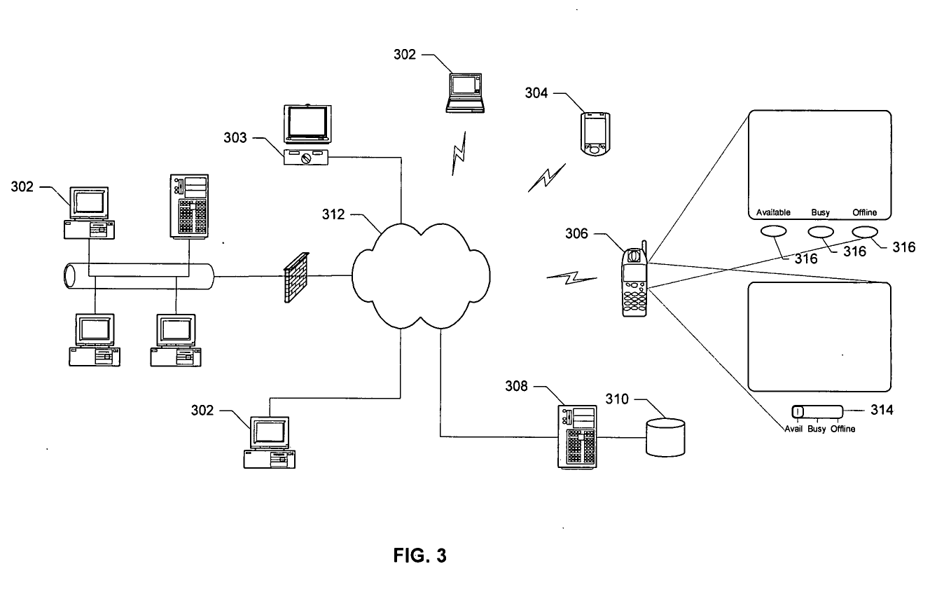

It should also be noted that the present invention may be implemented on any computing platform and in any network topology in which messaging is a useful functionality. For example and as illustrated in FIG. 3, implementations are contemplated in which the status controls described herein are provided on personal computers 302, media computing platforms 303 (e.g., gaming platforms, or cable and satellite set top boxes with navigation and recording capabilities (e.g., Tivo)), handheld computing devices (e.g., PDAs) 304, cell phones 306, or any other type of portable communication platform. As discussed above, such status controls may be resident on such devices, e.g., as part of a browser or other application, be served up from a remote site, e.g., in a Web page, (represented by server 308 and data store 310), or even be provided as a physical switch or button (e.g., 314) on a device, or as a soft key in combination with a switch (e.g., 316). The invention may also be practiced in a wide variety of network environments (represented by network 312), e.g., TCP/IP-based networks, telecommunications networks, wireless networks, etc.

While the invention has been particularly shown and described with reference to specific embodiments thereof, it will be understood by those skilled in the art that changes in the form and details of the disclosed embodiments may be made without departing from the spirit or scope of the invention. For example, the top level controls described above may control other functionalities of the messaging interface which relate to online presence. In one such example, a user has more than one online presence for his screen name (e.g., a personal/home presence and a professional/work presence) which he manages differently using visibility profile information specified by or associated with the user. Thus, if the user is at home or on personal time, he may activate his home presence which makes his online presence visible to personal contacts. By contrast, when he is at work, he may select his work presence which makes his online status visible to his professional contacts. According to a specific embodiment of the invention, the mechanism for switching between or selecting these different online presences is provided as a top level control as described above.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for controlling an online status of a user in a network, the method comprising:
providing a messaging interface with which the user may initiate communication with other users in the network, the messaging interface including first status information representing the online status of the user, the messaging interface further including a status control element which is visible in the messaging interface without requiring action by the user;
providing second status information representing the online status of the user to selected ones of the other users; and
in response to selection of the status control element, updating the first and second status information to represent a corresponding change of the online status of the user, wherein the selection of the status control element requires only a single selection action by the user.

2. The method of claim 1 wherein the status control element comprises one of a plurality of status control elements, each of the status control elements corresponding to one of a plurality of states of the online status of the user.

3. The method of claim 1 wherein the status control element corresponds to at least one of a plurality of states of the online status of the user, the plurality of states including any of available, unavailable, busy, not at my desk, be right back, invisible, stepped out, on the phone, in a meeting, offsite, offline, online, and a user-defined profile.

4. The method of claim 1 wherein the status control element is operable to effect toggling between multiple states of the online status of the user.

5. The method of claim 1 further comprising enabling the user to add an additional status control element to the messaging interface.

6. The method of claim 1 wherein the status control element comprises any of a button, a slider, or a radio control.

7. The method of claim 1 wherein the messaging interface is presented on any of a personal computer, media computing platform, a handheld computing device, and a wireless communication device.

8. The method of claim 1 wherein the status control element represents at least a portion of the first status information.

9. A messaging system operating in a network comprising at least one network device which is operable to:
provide a messaging interface on a device in the network with which a user may communicate with other users in the network, the messaging interface including first status information representing an online status of the user, the messaging interface further including a status control element which is visible in the messaging interface without requiring action by the user;
provide second status information representing the online status of the user on other devices on the network associated with selected ones of the other users; and
update the first and second status information to represent a corresponding change of the online status of the user in response to selection of the status control element, wherein the selection of the status control element requires only a single selection action by the user.

10. The messaging system of claim 9 wherein the status control element comprises one of a plurality of status control elements, each of the status control elements corresponding to one of a plurality of states of the online status of the user.

11. The messaging system of claim 9 wherein the status control element corresponds to at least one of a plurality of states of the online status of the user, the plurality of states including any of available, unavailable, busy, not at my desk, be right back, invisible, stepped out, on the phone, in a meeting, offsite, offline, online, and a user-defined profile.

12. The messaging system of claim 9 wherein the status control element is operable to effect toggling between multiple states of the online status of the user.

13. The messaging system of claim 9 wherein the at least one network device is further operable to enable the user to add an additional status control element to the messaging interface.

14. The messaging system of claim 9 wherein the status control element comprises any of a button, a slider, and a radio control.

15. The messaging system of claim 9 wherein the device and other devices comprise any of a personal computer, a media computing platform, a handheld computing device, and a wireless communication device.

16. The messaging system of claim 9 wherein the status control element represents at least a portion of the first status information.

17. A computer program product comprising at least one computer-readable medium having computer program instructions stored therein which are operable to cause at least one computer to:
provide a messaging interface with which a user may communicate with other users in a network, the messaging interface including first status information representing an online status of the user, the messaging interface further including a status control element which is visible in the messaging interface without requiring action by the user;
provide second status information representing the online status of the user to selected ones of the other users; and
update the first and second status information to represent a corresponding change of the online status of the user in response to selection of the status control element, wherein the selection of the status control element requires only a single selection action by the user.

18. A device with which a user may communicate with other users in a network, the device comprising a display, a processor, memory having computer-program instructions stored therein, an interface to the network, and at least one switch operable to control an online status of the user in the network, the processor being operable in conjunction with the computer program instructions to:
provide a messaging interface on the display with which the user may initiate communication with other users in the network, the messaging interface including first status information representing the online status of the user, the first status information corresponding to second status information representing the online status of the user to selected ones of the other users on corresponding devices; and
in response to operation of the at least one switch, update the first status information to represent a corresponding change of the online status of the user, and communicate the change of the online status to the network via the interface such that the change is reflected in the second status information.
